(19) United States
(12) Patent Application Publication
(10) Pub. No.: US 2014/0374127 A1
(43) Pub. Date: Dec. 25, 2014

(54) SYSTEM FOR SELF-PROTECTION AGAINST FOREST FIRES IN AN URBAN FOREST INTERFACE

(71) Applicant: MEDI XXI GSA, S.L., Carcaixent (ES)

(72) Inventor: Ferran Dalmau Rovira, Carcaixent (ES)

(21) Appl. No.: 14/371,583

(22) PCT Filed: Jan. 14, 2013
(86) PCT No.: PCT/ES2013/070007

§ 371 Date: Jul. 10, 2014

(30) Foreign Application Priority Data
Jan. 13, 2012 (ES) 201230046

(51) Int. Cl. A62C 3/02; A62C 35/68

(52) U.S. Cl. CPC A62C 3/0278; A62C 35/68
USPC 169/48

(57) ABSTRACT

The invention relates to a system for self-protection against forest fires, especially for the protection of urban communities (1) close to forest areas (2), which comprises creating a protective area (3) around the urban community (1) to be protected and assembling in said area a hydraulic water supply system (4) capable of covering at least the protective area.

### FIELD OF THE INVENTION

The present invention relates to a system for self-protection against forest fires especially designed for protecting constructions, homes, industrial installations, urban communities, etc., which are surrounded by or close to woods or forest areas.

The system of the invention represents a huge advantage in the intervention in emergencies in the fight against forest fires today, as well as for civil protection of people living in populated groups or homes located in forest areas given that it considerably improves the safety conditions of any person or structure which may be affected by the fire.

The system of the invention is based on the combination of preventive planning, which adapts to each specific situation, and in the arrangement or installation of hydraulic and technical means intended for preventing or obstructing the fire from spreading from forest area towards the structure or urban community to be protected.

### BACKGROUND OF THE INVENTION

Currently, when a forest fire occurs, the intervention of fire fighting units (fire trucks, helicopters and airplanes with water loads . . . ) is necessary such that these units are forced to work in areas close to urban communities, creating the risk inherent to their actions due to the proximity to the populated area.

Furthermore, the homes which usually do not have self-protection means are completely unprotected.

In some cases the fight against forest fires is also accompanied by the prior installation of fire hydrants to which hoses have to be connected for defending against the fire, which is an obvious drawback because of the need to get to them and because of the limitation which their location (forest area with risk of burning) can cause.

As a preventive measure, there are also the so-called firebreaks which consist of areas of separation between forest stands for the purpose of preventing fires from spreading from one stand to another.

### DESCRIPTION OF THE INVENTION

The object of the present invention is a system for self-protection against fires, applicable to protecting urban communities, industrial installations, homes and the like which are surrounded by or close to forest stands at risk of being reached by a possible fire of said stands.

The system of the invention is essentially based on creating an area lacking combustible vegetation and a damp outer area surrounding the community or structure to be protected and being preventive in nature.

The system of the invention comprises the preventive creation of a protective area around the urban community or installation to be protected, isolating said community from the forest environment, and the assembly of a hydraulic water supply system in said area capable of covering at least the protective area. This protective area is formed by a perimeter strip cleared of combustible vegetation surrounding the urban community or structure and sized to serve as a firebreak between the forest stand and the community or structure to be protected.

The hydraulic system comprises water sprinklers capable of covering the protective perimeter strip. These water sprinklers are fed from at least one supply system or deposit by means of impeller pumps and conduits.

The invention therefore combines the creation of a protective perimeter strip by means of forestry activities with the installation of hydraulic and technical means which allow wetting said area for the purpose of increasing the dampness thereof, being able to further implement additives, preventing or obstructing the fire from spreading towards the interior of the urban community. The hydraulic means can also be installed on the structure or building to be protected.

The protective perimeter strip is achieved by means of preventive forestry planning works in the perimeter strip and areas adjacent to the urban community or home to be protected, such that a firebreak area completely cleared of vegetation is produced, safely isolating the urban community or construction from the forest stand for which protection is desired.

Once the previous planning has been carried out, the hydraulic system is then designed, preferably from existing deposits, such as swimming pools, water deposits, etc., although they can be built for that purpose if necessary.

The installation will comprise a series of conduits and impeller pumps which will preferably be supplied by means of a connection to the power grid and a generator which will provide the system with power independence because the power supply is usually interrupted in fire situations.

The water sprinklers can consist of water cannons which are assembled in columns arranged on the protective area.

For isolated constructions the water sprinklers can consist of sprinklers which are assembled on the structure or building to be protected and are aimed at said structure. These water sprinklers can be assembled in a metal chassis and be complemented with water diffusers assembled in a protective perimeter strip surrounding or encircling the home.

The hydraulic system requires independent power autonomy, such that its operation is assured even if a power grid failure occurs so the automated part of said grid will be designed to operate with a photovoltaic solar power installation connected to batteries or a diesel pump, although it can also be connected to the power grid, and with an emergency activation method.

The system of the invention is applicable both for protecting urban communities and for lines of defense supported on infrastructures or for protecting isolated buildings and homes.

### BRIEF DESCRIPTION OF THE DRAWINGS

The attached drawings show the schematic development of the system of the invention by way of non-limiting example.

In the drawings:

FIG. 1 shows a plan schematic view of the protection system of the invention applied to an urban community or area.

FIG. 2 shows an elevational view of part of the hydraulic system included in the system of the invention.

FIG. 3 shows a perspective view of the application of the system of the invention to the protection of a home.

FIG. 4 is a plan view of the system of FIG. 3.

FIG. 5 shows an elevational view of an embodiment variant with respect to the system shown in FIG. 3.

FIG. 6 shows a perspective view of a device for automatically activating specific water sprinklers, depending on the direction of the wind blowing at all times.

FIG. 7 is a diagram of a control system with the device of FIG. 6.

### DETAILED DESCRIPTION OF AN EMBODIMENT

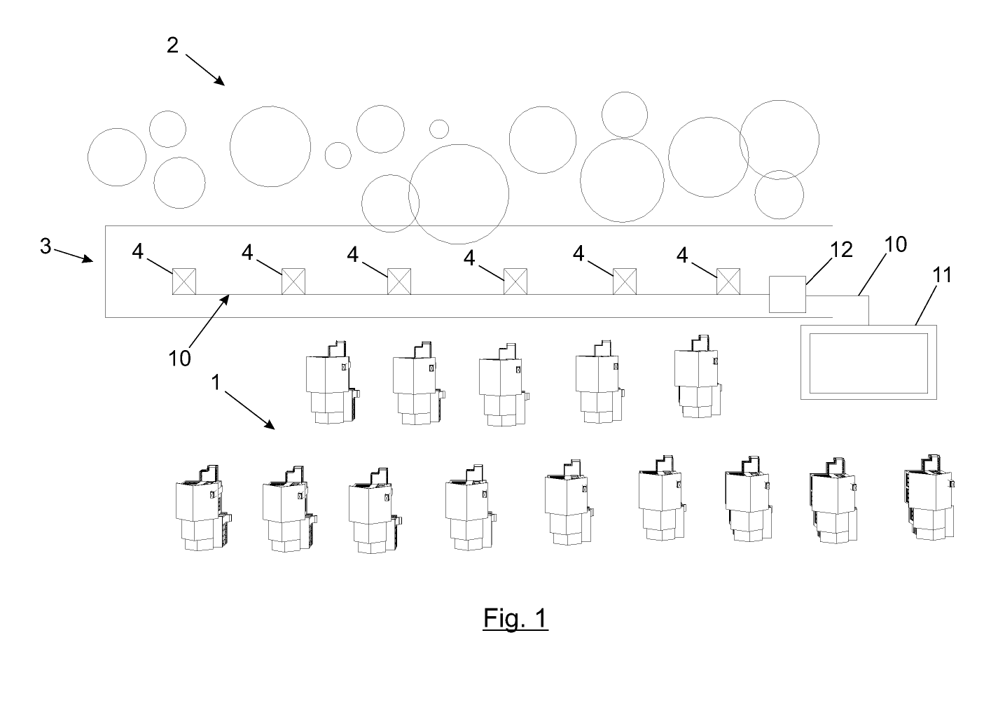

FIG. 1 schematically shows an urban community 1 which is surrounded by or close to a forest area 2.

To protect the urban community 1, a protective area 3 isolating said community from the forest environment 2 is created around said urban community according to the system of the invention. This area consists of a perimeter strip separating or surrounding the urban community with respect to the forest area 2, which strip will be cleared of combustible vegetation to serve or act as a firebreak between the urban community 1 and the forest stand 2.

Preventive forestry projects and works as well as forest clearing will be performed in the perimeter strip 3 such that there is a firebreak area or strip completely clear of vegetation, completely isolating the urban community 1 from the forest stand 2.

Once the previous planning has been carried out, a hydraulic water supply system is assembled in the area 3 that is capable of covering at least this protective area 3. To that end hydrants connected in a network to a series of automated water monitors allowing remote activation are assembled in the area or strip for the purpose of isolating the urban community or the home to be protected from the forest area 2. This protection is achieved by means of the discontinuity of combustible vegetation and the creation of a damp area based on the mentioned hydrants.

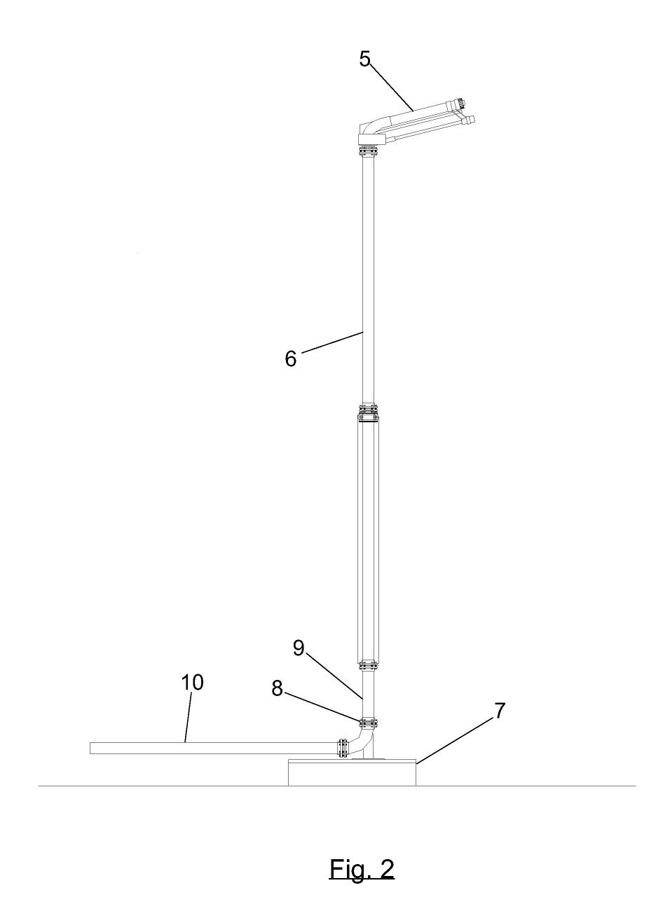

As shown in FIG. 2, the hydrants 4 can consist of water cannons 5 which are assembled on or supported by a column 6 fixed or assembled on a footing 7, at the base of which there is a hydrant 8 with a shut-off valve 9 controlling the passage of water supplied through the conduit 10 from a supply system or from an existing water deposit, such as a swimming pool 11 or the like.

The installation further includes pumping equipment 12 taking the water from the deposit 11 and impelling it through the conduits 10, the layout of which will be established according to the specific area where the fire defense is installed, the pipes being able to be buried or be above ground. The impeller equipment 12 will be powered by a generator providing it with power independence.

The columns 6 supporting the hydrants 5 can fixed, based on towers assembled on footings 7, as indicated, or they can be mobile, formed by movable supports.

A range varying between 15 and 70 meters can be achieved by means of the water cannons, which thereby allows projecting the water the desired distance such that the dampness of the vegetation is maintained, preventing the fire from spreading through the protective area 3.

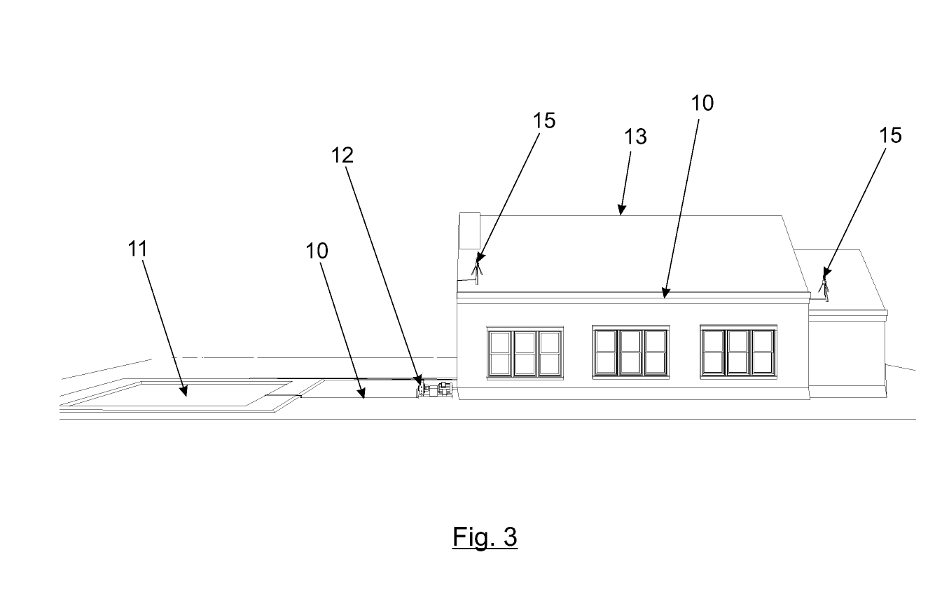

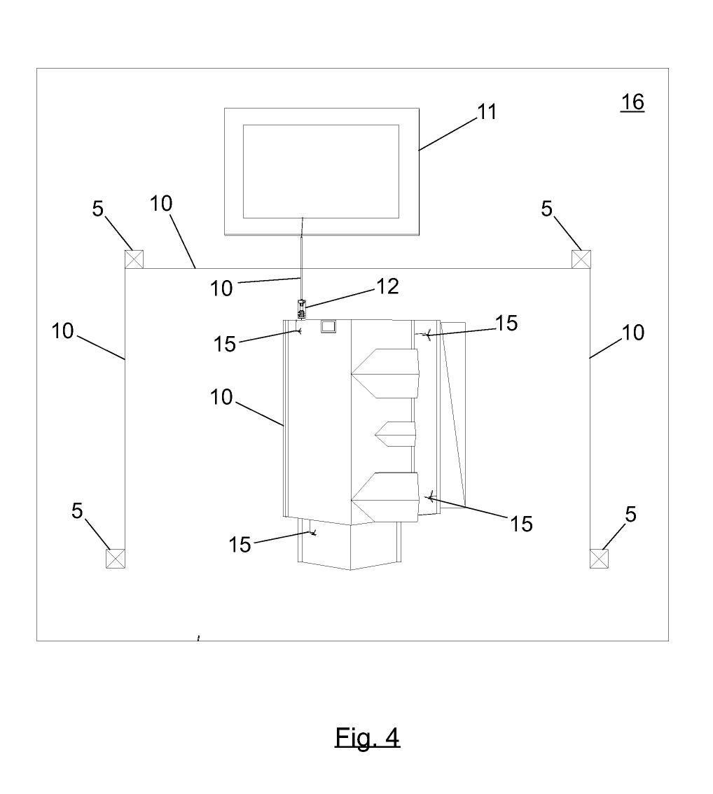

The system of the invention is also applicable to the protection of individual structures or buildings as depicted in FIGS. 3 and 4. In this case a home 13 built within an area or plot 14 is protected by means of an installation comprising, as in the case of FIGS. 1 and 2, conduits 10 through which, and by means of impeller equipment 12, water is supplied under pressure, for example from a swimming pool 11. The conduits 10 can feed water cannons 5 and also sprinklers 15 assembled on the structure of the building 13 and aimed at it. A peripheral protective area around the home 13 is thereby maintained through the cannons 5, and at the same time the protection of the home 13 itself is assured by means of sprinklers 15.

Both in the example of FIGS. 1 and 2 and in that shown in FIGS. 3 and 4, the system is based on the creation of protective perimeter strip or area by means of preventive forestry to attempt to isolate the urban community 1 or home 13 from the adjacent forest area 2, or at least minimizing the spread of fire towards the area or structure to be protected, and in the subsequent hydraulic system, based on a system of water sprinklers or supply devices which, together with preventive forestry tasks, has the purpose of isolating the populated community from the forest area, and vice versa, along the entire perimeter by means of the creation of an area of discontinuity of combustible vegetation and a damp area.

Additives such as foaming agents, retardants, etc. . . . can be used through the hydraulic system in cases of dire need,

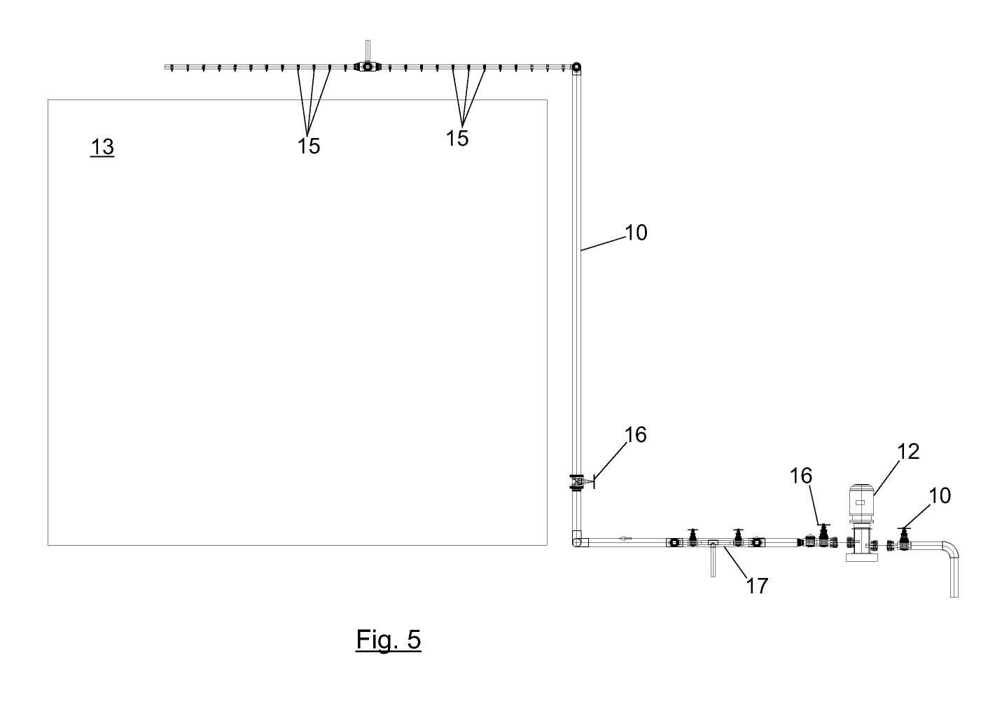

FIG. 5 shows an embodiment variant for protecting a building or home 13 including, as in the preceding cases, a water supply conduit 10 from a water containing deposit, such as a swimming pool, from where water is drawn in by impeller equipment 12 feeding many sprinklers 15 installed on the roof of the home or establishment 13. The conduit 10 can include shut-off valves 16 as well as an additive injection system 17.

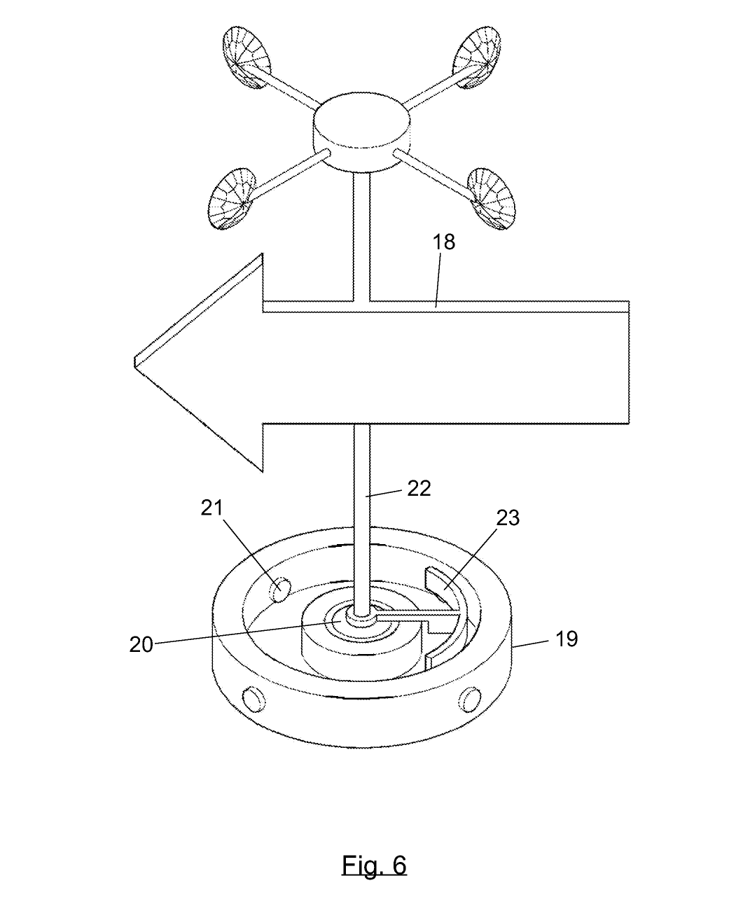

FIG. 6 shows a device responsible for automatically activating specific water cannons 5 or sprinklers 15. This device is formed by a weathervane 18 oriented by the action of the wind which is assembled with the ability to rotate freely in a base 19, for example through a bearing 20. The base 19 has a series of sensors 21. The rod or mast 22 of the weathervane 18 has an arm 23 fixed thereto which is driven by the rotation of the weathervane 18, facing a sensor 21 for activation thereof. The activation of this sensor will cause the installation to operate through the cannons 5 or sprinklers 15 which are located precisely on the side from where the wind originates and will be the area or the side at risk in the event of a fire in the adjacent forest stand.

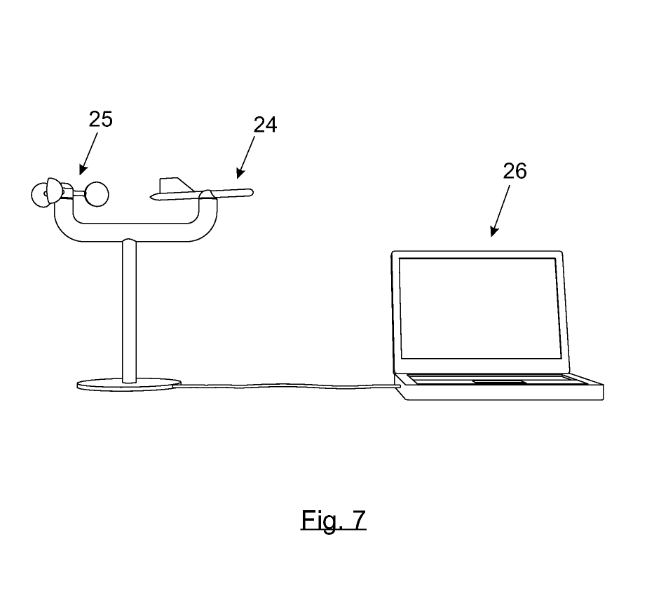

FIG. 7 schematically shows a control system including a weathervane 24 which can correspond with the constitution of the device of FIG. 6, and an air speed indicator 25, the data of which is supplied to a home automation control system 26 for the automatic control of the self-protection system object of the invention.

1. A system for self-protection against forest fires especially for protecting homes or urban communities adjacent or close to forest areas, characterized in that it comprises:
creating a protective area around the urban community to be protected, isolating said community from the forest environment; and
assembling in said area a hydraulic water supply system capable of covering at least the protective area;
which protective area is formed by a perimeter strip cleared of combustible vegetation surrounding the urban community and sized to serve as a firebreak between the forest stand and the urban community; and which hydraulic system comprises water sprinklers capable of covering the perimeter strip, activation means for activating said sprinklers and impeller pumps and conduits for impelling water from a water containing deposit.

2. The system according to claim 1, characterized in that the water deposits consist of swimming pools or deposits existing in the urban community to be protected.

3. The system according to claim 1, characterized in that the water impeller pumps are operated by means of autonomous or home automation equipment.

4. The system according to claim 1, characterized in that the water sprinklers consist of water cannons which are supported by columns assembled in the protective area.

5. The system according to claim 1, characterized in that the water sprinklers consist of diffusers or sprayers which are assembled on the structure or building to be protected and are aimed at said structure by means of a chassis.

6. The system according to claim 1, characterized in that the water sprinklers consist of water cannons which are assembled in the protective perimeter strip and of water sprayers assembled on the structure to be protected.

7. The system according to claim 1, characterized in that the activation means for activating the sprinklers comprise a weathervane oriented by the wind which is assembled in a base having a series of sensors distributed around the circumference which can be selectively activated, depending on the wind direction, to turn the sprinklers located on the side from where the wind originates on to optimize water consumption as a limiting element.
